(19) United States
(12) Patent Application Publication
(10) Pub. No.: US 2007/0230903 A1
(43) Pub. Date: Oct. 4, 2007

(54) Data Processing Apparatus

(76) Inventors: Tomohiko Sakatani, Hyogo (JP); Kazuhiko Nakamura, Osaka (JP); Hideshi Ishihara, Osaka (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(21) Appl. No.: 11/570,250

(22) PCT Filed: Jun. 10, 2005
(86) PCT No.: PCT/JP05/10715

§ 371 Date: Dec. 8, 2006

(30) Foreign Application Priority Data
Jun. 11, 2004 (JP) 2004-173505

(51) Int. Cl. G11B 20/10

(52) U.S. Cl. 386/92

(57) ABSTRACT

To record both of two digital broadcasts and/or a digital broadcast and an analog broadcast to be delivered by mutually different broadcasting systems even if they are scheduled to be transmitted in mutually overlapping time frames. A data processing apparatus receives a first broadcast signal and a second broadcast signal from mutually different broadcasting systems to record programs, represented by these broadcast signals, on at least one storage medium. The processor includes: a first receiving section to receive the first broadcast signal; a second receiving section to receive the second broadcast signal; a first stream processing section for outputting a stream of a first program represented by the first broadcast signal; a second stream processing section for outputting a stream of a second program represented by the second broadcast signal; and a stream control section that receives the first and second streams and writes the streams on the at least one storage medium in parallel with each other.

### TECHNICAL FIELD

The present invention relates to a technique of recording a broadcast program, for example, on a predetermined storage medium. More particularly, the present invention relates to a technique of recording a plurality of programs that are scheduled to be on air in mutually overlapping time frames.

### BACKGROUND ART

A DVD recorder has become more and more popular these days as an appliance for recording a broadcast program. The DVD recorder writes a data stream representing a program as an MPEG-2 program stream (which will be simply referred to herein as a “PS”) on a DVD. When receiving an analog broadcast, for example, the DVD recorder encodes the analog broadcast program into a PS and then writes it on a DVD.

Recently, the sources of broadcast TV programs have become even more various. In Japan, for example, digital broadcasting is also available in addition to the conventional analog broadcasting. The digital broadcasting includes BS digital broadcasting that uses radio waves transmitted from a broadcasting satellite, Cs digital broadcasting and terrestrial digital broadcasting, which was launched in 2003. In Japan, the service of the conventional terrestrial analog broadcasting is scheduled to stop in 2011, and therefore, the digital broadcasting is expected to become even more popular from now on.

In digital broadcasting, a pre-encoded data stream is transmitted. The stream format of digital broadcasting is MPEG-2 transport stream (which will be referred to herein as a “TS”), which is different from that of a PS. That is why no DVD recorders can write a TS, received as a digital broadcast, on a DVD as it is. Furthermore, the digital broadcasting sometimes provides a program with high definition video. The data rate of high definition video may exceed the maximum data rate as defined by the DVD standards. No DVD recorders can record a digital broadcast program for this reason, too.

In view of these considerations, recorders for recording a TS as it is on a hard disk drive (which will be referred to herein as an “HDD”), a D-VHS, or a Blu-ray Disc (BD) have been put on the market recently as the digital broadcasting has become increasingly popular.

Up to now, though, recorders currently available can record either only analog broadcasts or only digital broadcasts, not both.

A recorder normally has the function of executing a video recording operation according to recording schedule. When a plurality of programs are scheduling for recording in a single recorder, however, two of those programs may be on air in mutually overlapping time frames. In that case, the user needs to give up recording one of those two programs.

To cope with such an overlapped recording schedule, some recorder includes two analog tuners and performs a video recording operation using both of those tuners. Also, in digital broadcasting, the data of a plurality of programs may be transmitted in parallel as long as their channels (frequencies) are the same. Thus, Patent Document No. 1 proposes a method for recording a plurality of programs with the same frequency simultaneously and selectively playing back one of them. According to this technique, a plurality of programs can be recorded simultaneously and according to recording schedule even if they are scheduled to be on air in mutually overlapping time frames.

Patent Document No. 1: Japanese Patent Application Laid-Open Publication No. 2001-103405

### DISCLOSURE OF INVENTION

### Problems to be Solved by the Invention

If multiple analog tuners of the same type are provided to record a plurality of programs simultaneously, however, the cost increases naturally. Also, as far as digital broadcasting is concerned, only broadcast programs on the same channel (or with the same frequency) can be recorded at the same time. That is why programs scheduled for recording still cannot be recorded simultaneously if their recording schedules overlap with each other and if their broadcasting systems are different from each other (e.g., when one of them is a BS digital broadcast and the other is a terrestrial digital broadcast).

Furthermore, analog broadcasts and digital broadcasts are both currently available and there are various types of storage media to record them. Under the circumstances such as these, a single recorder should preferably be able to record programs provided from various broadcasting sources in accordance with the compatibility between the format of each broadcasting source and that of the data that is storable on a storage medium. Also, these situations will persist for at least several more years. This is because it is determined by the geography and other factors of a particular area whether or not terrestrial digital broadcasts can be received in that area. That is why to expand the receivable area, the broadcasters need to explore other options. Consequently, the transition period of a certain length would be necessary before the current terrestrial analog broadcasting is completely switched into digital broadcasting.

An object of the present invention is to record both of two digital broadcasts and/or a digital broadcast and an analog broadcast to be delivered by mutually different broadcasting systems even if they are scheduled to be transmitted in mutually overlapping time frames.

### Means for Solving the Problems

A data processing apparatus according to the present invention receives a first broadcast signal and a second broadcast signal from mutually different broadcasting systems to record programs, represented by these broadcast signals, on at least one storage medium. The processor includes: a first receiving section to receive the first broadcast signal; a second receiving section to receive the second broadcast signal; a first stream processing section for outputting a stream of a first program represented by the first broadcast signal; a second stream processing section for outputting a stream of a second program represented by the second broadcast signal; and a stream control section that receives the first and second streams and writes the streams on the at least one storage medium in parallel with each other.

The first receiving section may receive an analog broadcast signal as the first broadcast signal. The second receiving section may receive a digital broadcast signal as the second broadcast signal. The first stream processing section may generate the first stream by encoding data derived from the analog broadcast signal. And the second stream processing section may generate the second stream based on a data stream derived from the digital broadcast signal.

The stream control section may write the first and second streams on the same storage medium.

The stream control section may write the first and second streams on two different storage media, respectively.

The data processing apparatus may further include a recording control section that receives time information specifying a recording start time and a recording end time, thereby controlling program recording in accordance with the time information. If it has been instructed to record first and second programs, which are to be delivered by a first broadcasting system in mutually overlapping time frames and if the second program is also available by simultaneous broadcasting, the recording control section may instruct the first receiving section to receive the first broadcast signal as for the first program and may also instruct the second receiving section to receive the second broadcast signal from a second broadcasting system as for the second program.

The second stream processing section may have obtained in advance program guide data, specifying the on-air time of the second program to be broadcast by the second broadcasting system, from the second broadcast signal. By reference to the program guide data, the recording control section may tell the second receiving section that the second program is available by the simultaneous broadcasting.

The recording control section may output a signal notifying that the second program has been found to be available by the simultaneous broadcasting and is recordable by the second broadcasting system.

The recording control section may receive a response to the notifying signal and may give an instruction to the second receiving section.

### Effects of the Invention

A data processing apparatus according to the present invention can record both of two programs of mutually different broadcasting systems using a minimum required configuration.

Among other things, even if two programs of the same broadcasting system should be recorded in mutually overlapping time frames but if one of the two programs is also available by simultaneous broadcasting, then that program is received through a different broadcasting system. As a result, both of the two programs can be recorded.

### BRIEF DESCRIPTION OF DRAWINGS

FIG. 1 shows a configuration for a system that is made up of an optical disk recorder 10 with a built-in HDD according to a preferred embodiment of the present invention and other devices.

FIG. 2 shows the data structure of a transport stream (TS) 20.

FIG. 3(a) shows the data structure of a video TS packet 30, FIG. 3(b) shows the data structure of an audio TS packet 31 and FIG. 3(c) shows the data structure of an EIT packet 32.

Portions (a) to (d) of FIG. 4 show a stream correlation to be established when video pictures are played back from video TS packets.

FIG. 5 shows the data structure of an MPEG2 program stream 50 compliant with the DVD Video Recording standard.

FIG. 6 shows the data structure of a video pack in the program stream 50.

FIG. 7 shows an arrangement of functional blocks for the recorder 10.

FIG. 8 is a flowchart showing the procedure of recording schedule replacing processing that uses simultaneous broadcasting.

FIGS. 9(a) through 9(d) show exemplary tables and messages to be displayed while programs are scheduled for recording by using simultaneous broadcasting.

### DESCRIPTION OF REFERENCE NUMERALS

10 optical disk recorder with built-in HDD
14 optical disk
100 AV source output section
101 analog tuner
102 AGC
103 A/D converter
104 MPEG2-PS encoder
105 digital tuner
106 transport decoder
107 EPG management section
200 HDD
300 control section
301 stream control section
302 MPEG2-PS decoder
303 MPEG2-TS decoder
304 GFX control section
305 D/A converter
306, 307, 308, 309 switch
310 scheduled recording control section
311 video output control section
400 operating section
500 set top box
501 network
502 server

### BEST MODE FOR CARRYING OUT THE INVENTION

Hereinafter, a preferred embodiment of a content recorder according to the present invention will be described with reference to the accompanying drawings. In the following preferred embodiment, the content is supposed to be an analog broadcast program and/or a digital broadcast program and the data processing apparatus is supposed to be an optical disk recorder with a built-in HDD.

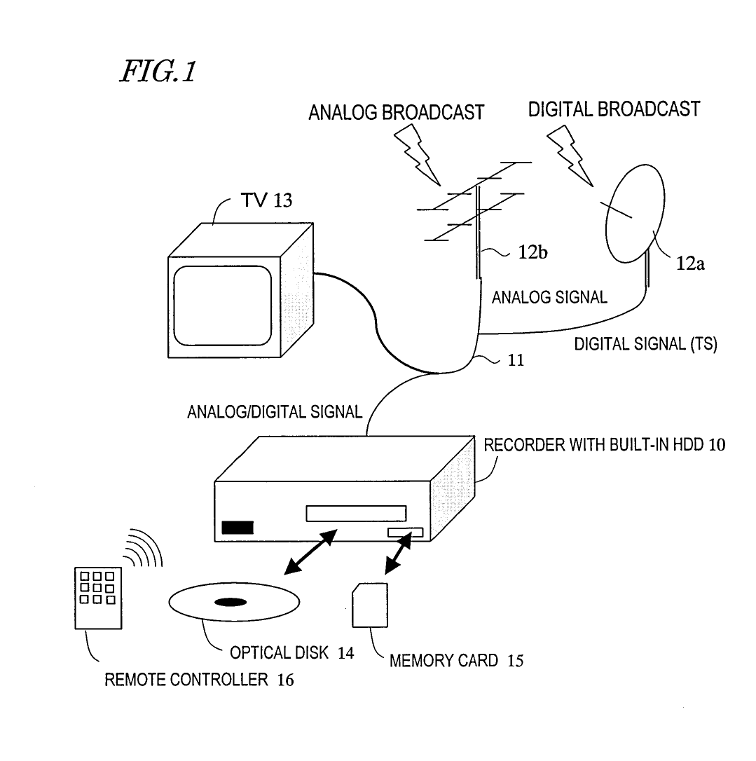

FIG. 1 illustrates a configuration for a system that is made up of an optical disk recorder 10 with a built-in HDD according to a preferred embodiment of the present invention and other devices. First of all, the optical disk recorder 10 with the built-in HDD (which will be simply referred to herein as a “recorder 10”) is supposed to implement one analog tuner and one digital tuner. This is because if analog and digital broadcasts are transmitted in parallel with each other, the function of receiving and recording both of the digital and analog broadcasts is needed at least. It should be noted that the analog and digital broadcasts are taken as examples of two different broadcasting systems. The “broadcasting systems” are different depending on not only whether the content is transmitted by an analog system or a digital system but also whether the digital broadcast is a BS digital broadcast or a terrestrial digital broadcast because these two digital broadcasts use mutually different frequencies. In addition, the broadcasting systems may also be regarded herein as different ones depending on whether the broadcast has been transmitted wirelessly or through a wire such as a cable.

However, according to this preferred embodiment, no more analog tuners and/or digital tuners are supposed to be added. This is because to add a piece of hardware such as a tuner means increasing the manufacturing cost of the recorder 10. Besides, if hardware is added, then the housing of the recorder 10 becomes bigger. None of these is beneficial for the users. The recorder 10 of this preferred embodiment performs the processing efficiently by using minimum required integral components as will be described later.

Hereinafter, the functions of the recorder 10 will be outlined first, and then the data structure of a data stream to be processed by the recorder 10 and the respective components and operation of the recorder 10 will be described.

The recorder 10 has a recording function, i.e., can record digitally a moving picture data stream representing the video and audio of a broadcast program on the HDD (not shown) and/or on an optical disk 14. The optical disk 14 may be either a Blu-ray Disc (BD) or a recordable DVD such as a DVD-RAM. And the recorder 10 can record a stream representing a broadcast program on both of a BD and a DVD. In the following description, when these two types of optical disks need to be distinguished from each other, they will be referred to herein as the “BD 14” and the “DVD 14”. The data stream to be recorded on the BD has a format of an MPEG-2 transport stream (TS). On the other hand, the data stream to be recorded on the DVD has a format of an MPEG-2 program stream (PS).

The recorder 10 also has a playback function, i.e., can read the data stream that has been recorded on the optical disk 14 and play back the moving picture. FIG. 1 shows other devices that can operate in conjunction with the recorder 10 to execute its recording and playback functions. The recorder 10 performs its recording and playback functions in response to an instruction that has been given by user through an input device such as a remote controller 16 or buttons (not shown) on the front side of the recorder 10.

First, the processing to be done by the recorder 10 to execute its recording function will be described. The recorder 10 is connected to an antenna 12a that receives a digital signal representing a digital broadcast program and to an antenna 12b that receives an analog signal representing an analog broadcast program, and receives a digital signal and an analog signal. The recorder 10 may receive the digital signal and the analog signal through a coaxial cable 11, for example. The stream format of the digital signal is TS.

When an analog broadcast program is received, the recorder 10 generates a PS from the analog signal and records the PS on either the DVD 14 or the HDD. On the other hand, when a digital broadcast program is received, the recorder 10 receives a TS and records the TS on either the BD 14 or the HDD. Strictly speaking, a stream that is different from the partial TS (i.e., a clip AV stream) is recorded on the BD 14. A clip AV stream is generated by adding 4-byte information (such as time information representing the packet arrival time) to each of the packets that form a partial TS. Except for the addition of such information, the packet structure of the clip AV stream is identical with that of the partial TS. That is why in the following description, the clip AV stream and the partial TS will be regarded as substantially identical with each other. And the partial TS is supposed to be recordable on the BD 14, for example.

The recorder 10 can also record a broadcast program on a memory card 15 such as an SD memory card or a memory stick™.

Next, the processing to be done by the recorder 10 to execute its playback function will be described. The recorder 10 reads and decodes a stream that has been recorded on the HDD or the optical disk 14, thereby getting video and audio data. Then, the recorder 10 outputs the data to a TV 13 and loudspeakers (not shown), thereby playing back the video and audio.

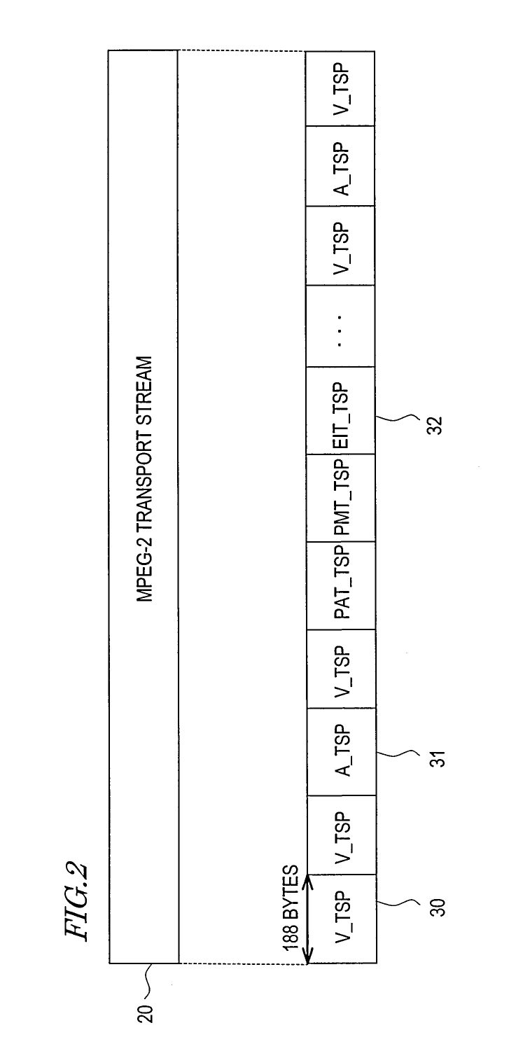

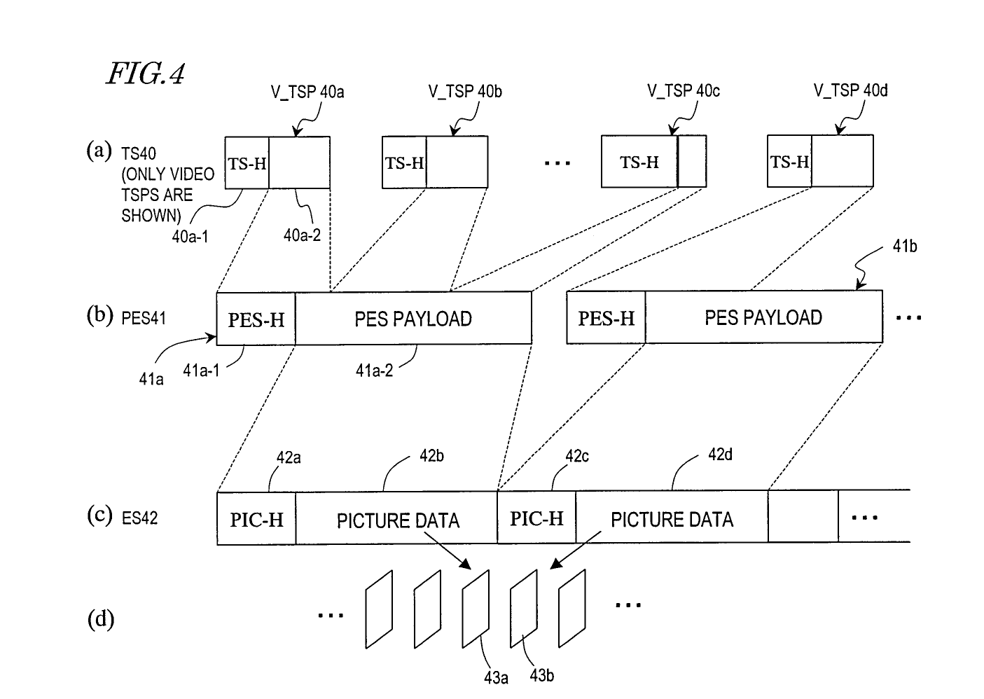

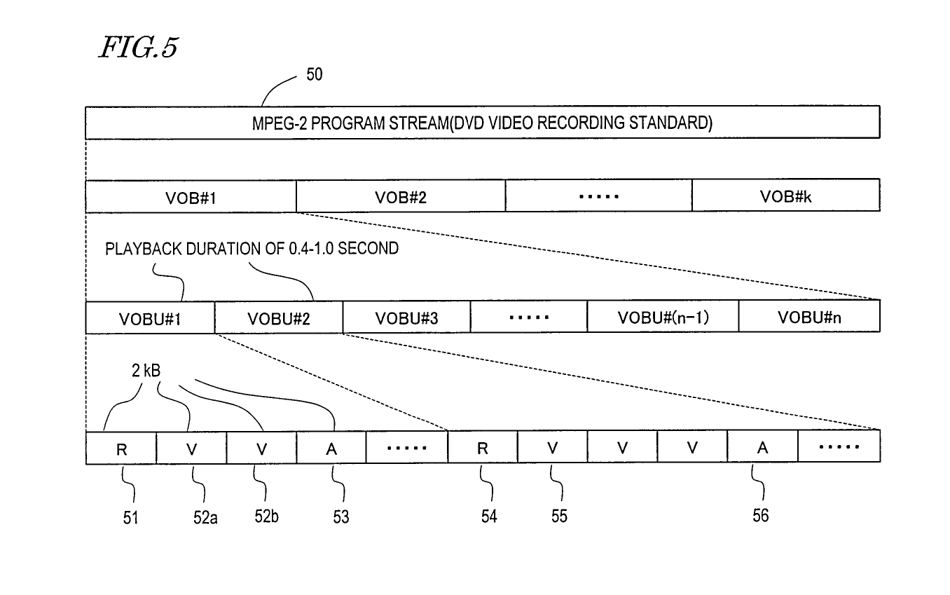

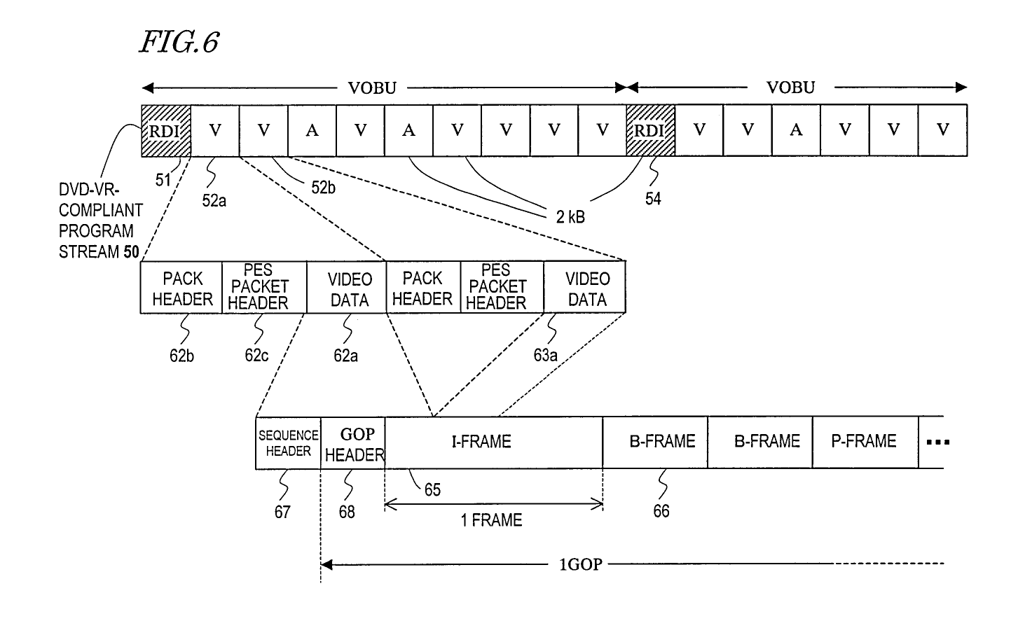

Hereinafter, the data structure of a transport stream will be described with reference to FIGS. 2 through 4. After that, the data structure of a program stream will be described with reference to FIGS. 5 and 6.

FIG. 2 shows the data structure of a transport stream (TS) 20. Examples of TS packets include a video TS packet (V_TSP) 30 in which compressed video data is stored, an audio TS packet (A_TSP) 31 in which compressed audio data is stored, a packet (PAT_TSP) in which a program association table (PAT) is stored, a packet (PMT_TSP) in which a program map table (PMT) is stored, and a packet (EIT_TSP) in which an event information table (EIT) is stored. Each of these packets has a data size of 188 bytes.

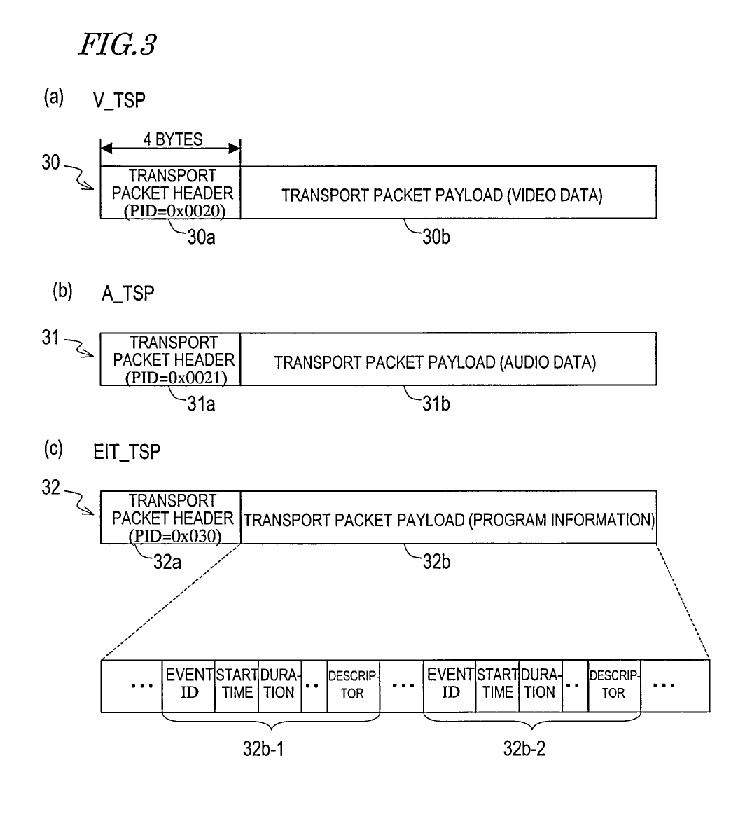

Hereinafter, the video TS packets, audio TS packets, and EIT packets, all of which are relevant to the processing of the present invention, will be described. FIG. 3(a) shows the data structure of a video TS packet 30. The video TS packet 30 includes a transport packet header 30a of 4 bytes and transport packet payload 30b of 184 bytes. Video data 30b is stored in the payload 30b. On the other hand, FIG. 3(b) shows the data structure of an audio TS packet 31. The audio TS packet 31 also includes a transport packet header 31a of 4 bytes and transport packet payload 31b of 184 bytes. Audio data 31b is stored in the transport packet payload 31b.

FIG. 3(c) shows the data structure of an EIT packet 32. The EIT packet 32 includes a transport packet header 32a of 4 bytes and transport packet payload 32b of 184 bytes. An event information table EIT is stored as program information in the payload 32b.

As can be seen from this example, a TS packet is usually made up of a transport packet header of 4 bytes and a payload of 184 bytes. In the packet header, a packet identifier (PID) showing the type of that packet is described. For example, the PID of a video TS packet is 0x0020, while that of an audio TS packet is 0x0021.

Elementary data, program information and so on are stored in the payload. The elementary data may be content data such as video data or audio data or control data for controlling the playback. The type of the data stored there changes according to the type of the packet.

The event information table EIT corresponding to the program information defines an event identifier (event ID), which is the identifier of each program, the scheduled broadcasting time (including the broadcast start time and duration) of each program, title information, and so on.

In the program information, either only information about the program currently on air and the next program or information about programs that are scheduled to be on air in a time frame of eight days from now is stored. The former type of information is called an “event information table-EIT-actual” and is used to see if the program which is scheduled for recording is actually on air now, i.e., to determine exactly when its video recording operation should be started and ended. The latter type of information is called an “event information table EIT-schedule” and is used to compile a program list by collecting multiple pieces of program information together. In the following description, if there is no need to distinguish one of these two types of tables from the other, the table will be simply referred to herein as an “event information table EIT”. The event information table EIT is transmitted repeatedly and continuously in the TS 20. However, since their amounts of information contained are different, the event information table EIT-actual can be transmitted in a relatively short time (e.g., every five seconds), while the event information table EIT-schedule is transmitted in a relatively long time.

The program information includes more than a piece of event unique information 32b-1, 32b-2, etc. The number of these pieces of event unique information is equal to the number of programs on a single channel. A first piece of event unique information 32b-1 includes an event ID to identify each of the programs that are scheduled to be on air, the start time and duration of each program, and a descriptor in which the title of the program is stored. The same statement applies to the event unique information 32b-2 and so on. The “start time” is indicated as Japanese standard time (JST) and modified Julian date (MJD). On the other hand, the “duration” represents the duration of a program in hours, minutes and seconds. For example, 1 hour 45 minutes 30 seconds is represented as “0x014530”, which is a hexadecimal number. The descriptor stores the title of the program, for instance.

Hereinafter, the relationship between video data and pictures that form video will be described as an example. Portions (a) to (d) of FIG. 4 show a stream correlation to be established when video pictures are played back from video TS packets. As shown in portion (a) of FIG. 4, the TS 40 includes video TS packets 40a through 40d. Although the TS 40 may include other packets, only those video TS packets are shown here. A video TS packet can be easily identifiable by the PID stored in its header 40a-1.

A packetized elementary stream is made up of the video data of respective video TS packets such as the video data 40a-2. Portion (b) of FIG. 4 shows the data structure of a packetized elementary stream (PES) 41. The PES 41 includes a plurality of PES packets 41a, 41b, etc. The PES packet 41a is made up of a PES header 41a-1 and PES payload 41a-2. These data are stored as the video data of the video TS packets.

Each PES payload 41a-2 includes the data of a single picture. An elementary stream is made up of those PES payloads 41a-2. Portion (c) of FIG. 4 shows the data structure of an elementary stream (ES) 42. The ES 42 includes multiple pairs of picture headers and picture data. It should be noted that the “picture” is generally used as a term that may refer to either a frame or a field.

In the picture header 42a shown in portion (c) of FIG. 4, a picture coding type, showing the picture type of picture data 42b that follows, is described. A picture coding type, showing the picture type of picture data 42d, is described in the picture header 42c. The “type” is one of an I-picture (intra-coded picture), a P-picture (predictive-coded picture) and a B-picture (bidirectionally-predictive-coded picture). If the type shows this is an I-picture, its picture coding type may be “001b”, for example.

The picture data 42b, 42d, etc. is data corresponding to a single frame, which may consist of either that data only or that data and preceding/succeeding data to be decoded before and/or after the former data. For example, portion (d) of FIG. 4 shows a picture 43a consisting of the picture data 42b and a picture 43b consisting of the picture data 42d.

In playing back video based on a TS, the recorder 10 gets video TS packets and extracts picture data by the processing described above, thereby getting pictures as components of video. As a result, the video can be presented on the TV 13.

FIG. 5 shows the data structure of an MPEG2 program stream 50 compliant with the DVD Video Recording standard (which will be referred to herein as the “VR standard”). This stream will be referred to herein as a “PS 50”.

The PS 50 includes a plurality of video objects (VOBs) #1, #2, . . . , and #k. Supposing the PS 50 is a recorded content, for example, each VOB stores moving picture data that was generated during a single video recording session (i.e., since the user started recording the video and until he or she stopped doing it).

Each VOB includes a plurality of VOB units (video object units; VOBUs) #1, #2, . . . , and #n. Each VOBU is a data unit containing data with a video playback duration of approximately 0.4 seconds to 1 second. Hereinafter, the data structure of VOBUs will be described with the first and second VOBUs taken as an example.

VOBU #1 is composed of a number of packs. In the PS 50, each pack has a fixed data length (also called a “pack length”) of 2 kilobytes (i.e., 2,048 bytes). At the top of the VOBU, a real time information pack (RDI pack) 51 is positioned as indicated by “R” in FIG. 5. The RDI pack 51 is followed by multiple video packs “V” (including video packs 52a, 52b, etc.) and multiple audio packs “A” (including audio pack 53).

Each pack stores the following information. The RDI pack 51 stores various information for controlling the playback of the PS 50, e.g., information representing the playback timing of the VOBU and information for controlling copying of the PS 50. The video packs 52a, 52b, etc. store MPEG2-compressed video data thereon. The audio packs 53, etc. store audio data that was compressed so as to comply with the MPEG2 Audio standard, for example. In adjacent video and audio packs, video and audio data to be played back synchronously with each other may be stored. However, those data may be arranged in any order.

VOBU #2 is also made up of a plurality of packs. An RDI pack 54 is arranged at the top of VOBU #2, and then followed by a plurality of video packs 55 and a plurality of audio packs 56. The contents of the information to be stored in each of these packs are similar to those of VOBU #1.

FIG. 6 shows the data structure of a video pack in the PS 50. The data structure of the video pack 52a will be described as an example. The video pack 52a stores MPEG2-compressed video data 62a therein. The video pack 52a further includes a pack header 62b and a PES packet header 62c indicating the identity as a video pack. Also, if the video pack 52a is the first one of the VOBU, a system header (not shown) is further included in the pack header 62b.

The video data 62a of the video pack 52a shown in FIG. 6, along with the video data 63a and so on of the following video packs 52b, etc., make up the data of an I-frame 65. After the I-frame, video packs making up a B-frame 66 or a P-frame are recorded continuously.

The video data 62a further includes a sequence header 67 and a GOP header 68. The MPEG2 standard defines a “group of pictures (GOP)” as a group of video frames. The GOP header 68 indicates the top of each GOP. The first frame of every GOP is always an I-frame.

It should be noted that the picture data shown in portion (c) of FIG. 4 (e.g., picture data 42b and 42d) and the frame data shown in FIG. 6 (e.g., data of the I-frame 65) are video data that has been compressed and encoded compliant with the MPEG-2 standard. If the picture data shown in portion (c) of FIG. 4 has standard resolution, the picture data may be the same as the frame data shown in FIG. 6. That is why if picture data is gotten from respective video TS packets, PS video packs can be generated easily by using the picture data, and vice versa. However, if the picture data shown in portion (c) of FIG. 4 has high resolution, then the picture data should be reconstructed into the frame data shown in FIG. 6 by decoding the data once, converting it into video of standard resolution through decimation, for example, and then encoding it again. As to audio, if audio data compliant with the AAC standard can be gotten from audio TS packets, for example, PS audio packs can be generated easily by using the audio data.

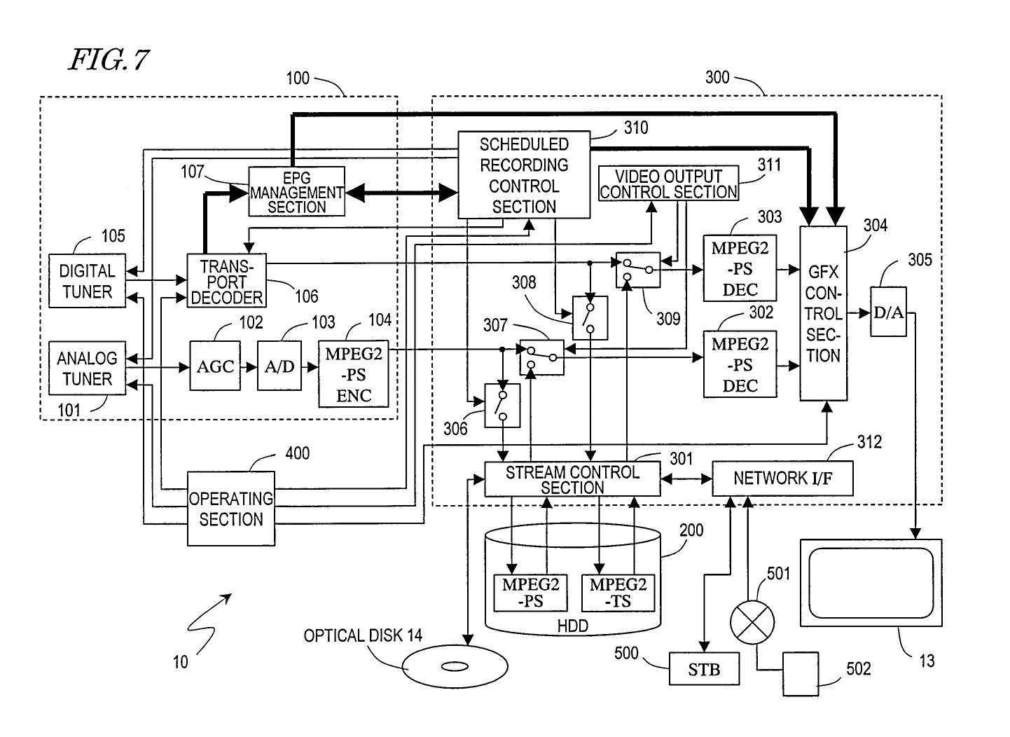

Hereinafter, a configuration for the recorder 10 of this preferred embodiment will be described with reference to FIG. 7, which shows an arrangement of functional blocks for the recorder 10. The recorder 10 includes an AV source output section 100, an HDD 200, a control section 300 and an operating section 400.

The AV source output section 100 outputs a digital broadcast program in the TS format and an analog broadcast program in the PS format, respectively. The HDD 200 can read and write a TS and a PS apparently simultaneously. The control section 300 controls recording of these two streams. The operating section 400 may be a switch on the housing or a remote controller 16 to allow the user to operate the recorder 10.

The AV source output section 100 includes a terrestrial analog tuner 101, an AGC 102, an A/D converter 103, an MPEG2-PS encoder 104, a terrestrial/satellite digital tuner 105, a transport decoder 106 and an EPG management section 107.

The analog tuner 101 receives an analog signal from the antenna 12b (see FIG. 1), tunes itself to a particular channel according to the frequency, and extracts only a signal representing a requested program. The analog tuner 101 is connected to the A/D converter 103 by way of the AGC (automatic gain control) 102. The AGC 102 automatically controls the amplitude levels of sync and data of the program signal. The A/D converter 103 converts the analog audio and video signals into digital ones and outputs them as a digital baseband signal. The MPEG2-PS encoder 104 generates an MPEG-PS by encoding the digital signal and then supplies it to the control section 300.

The digital tuner 105 receives a digital signal, including at least one program, from the antenna 12a (see FIG. 1). The MPEG2-TS to be transmitted as the digital signal includes packets representing a plurality of programs. Such a transport stream including packets representing a plurality of programs will be referred to herein as a “full TS”. The transport decoder 106 receives the TS, generates a data stream (which will be referred to herein as an “MPEG-2 partial transport stream (MPEG2-PTS)”) by extracting only a broadcast program on the desired channel from the TS, and supplies the MPEG2-PTS to the control section 300.

The packets on a desired channel may be extracted from the full TS in the following manner. Suppose the program number (or channel number) of the designated program is X. In that case, first, the full TS is searched for the program association table packet (i.e., PAT_TSP shown in FIG. 2). The packet ID (PID) of the program association table packet is always zero. Thus, a packet having that value may be searched for. In the program association table in the program association table packet, respective program numbers and the program map table packet PIDs (i.e., PMT_TSP shown in FIG. 2) of respective programs associated with those program numbers are stored. Thus, the packet ID (PID) of the program map table (PMT) associated with the program number X can be detected. The PID of the program map table PMT is supposed to be XX.

Next, when the program map table packet (i.e., PMT_TSP shown in FIG. 2) with PID=XX is extracted, a program map table PMT associated with the program number X can be obtained. The program map table PMT includes the PIDs of TS packets, in which the video and audio information of each program to watch and listen to is stored on a program-by-program basis. For example, the PID of the video information associated with the program number X may be XV and the PID of the audio information thereof may be XA. By using the PID (=XV) of the packet storing the video information and the PID (=XA) of the packet storing the audio information that have been obtained in this manner, the video and audio packets about a particular program can be extracted from a full TS.

In making a partial TS from a full TS, not only those packets that store the required video and audio information but also program specific information (PSI) packets and service information (SI) packets need to be extracted and corrected. As used herein, the PSI packets collectively refer to the program association table packets (PAT_TSP) and program map table packets (PMT_TSP) shown in FIG. 2. The PSI packets need to be corrected because the full TS and the partial TS include different numbers of programs, and therefore, the program association table and the program map table need to be adapted to the partial TS. On the other hand, the SI packets collectively refer to the EIT packets (EIT_TSP) shown in FIG. 2 and other packets. The SI packet includes data describing the contents, schedule/timings and so on of the programs included in the full TS and separately defined expansion information (which is also called “program service information”). In the full TS, the SI packet includes as many as 20 to 30 different types of data. Among these types of data, only important data for playing back the partial TS is extracted to generate a single SIT packet and multiplex it in the partial TS. Also, in the partial TS, information indicating that the stream is a partial TS (which is called a “partial transport stream descriptor”) is stored in the SIT packets. It is already a conventional technique to multiplex an SIT packet in a partial TS so as to comply with the European and Japanese digital broadcasting standards (DVB/ARIB).

By reference to the EIT packet 32 that has been extracted by the transport decoder 106 from the broadcast, the EPG management section 107 extracts, accumulates and manages the component data (program guide data) of the electronic program guides (EPGs) of the terrestrial analog and digital broadcasting. The program guide data is supplied to the control section 300. As for analog broadcasting, the program guide data of the G guide of analog broadcasting, corresponding to the electronic program guide, is broadcast as data on the mega-port channel of the BS digital broadcasting. That is why the program guide data of the analog broadcasting can be extracted using the digital tuner and the transport decoder 106.

The control section 300 includes a stream control section 301, an MPEG2-PS decoder 302, an MPEG2-TS decoder 303, a GFX control section 304, a D/A converter 305, switches (SWs) 306, 307, 308 and 309, a scheduled recording control section 310, a video output control section 311 and a network interface (I/F) 312.

The stream control section 301 is connected to the HDD 200 to control simultaneous reading and writing two types of data, included in a TS and a PS, from/on the HDD 200. The stream control section 301 is also connected to an optical disk drive (not shown) to control simultaneous reading and writing two types of data, included in a TS and a PS, from/on the optical disk 14 that has been loaded into the optical disk drive. If the given optical disk 14 is a DVD, the stream control section 301 controls reading and writing the PS. On the other hand, if the given optical disk 14 is a BD, then the stream control section 301 controls reading and writing the TS. The TS and PS may also be input through the network I/F 312.

The SW 306 includes an input terminal, which is connected to the output terminal of the MPEG2-PS encoder 104, and an output terminal, which is connected to the input terminal of the stream control section 301. When the SW 306 is closed, the input and output terminals thereof are connected together, thereby outputting the PS to the stream control section 301. It should be noted that when the SW 306 is closed, the stream is supposed to be recorded on either the HDD 200 or the optical disk 14. As to whether the stream should be recorded on the HDD 200 or on the optical disk 14, it may be determined upon the user's request, for example.

The SW 307 includes a first input terminal, which is connected to the output terminal of the MPEG2-PS encoder 104, a second input terminal, which is connected to the output terminal of the stream control section 301, and an output terminal, which is connected to the input terminal of the MPEG2-PS decoder 302. And a path is formed either between the first input terminal and the output terminal or between the second input terminal and the output terminal.

The SW 308 includes an input terminal, which is connected to the output terminal of the transport decoder 106, and an output terminal, which is connected to the input terminal of the stream control section 301. When the SW 308 is closed, the input and output terminals thereof are connected together, thereby outputting the TS to the stream control section 301. It should be noted that when the SW 308 is closed, the stream is supposed to be recorded on either the HDD 200 or the optical disk 14.

The SW 309 includes a first input terminal, which is connected to the output terminal of the transport decoder 106, a second input terminal, which is connected to the output terminal of the stream control section 301, and an output terminal, which is connected to the input terminal of the MPEG2-TS decoder 303. And a path is formed either between the first input terminal and the output terminal or between the second input terminal and the output terminal.

The respective outputs of the MPEG2-PS decoder 302, MPEG2-TS decoder 303 and EPG management section 107 are supplied to the graphics (GFX) control section 304. More specifically, digital signals representing programs are output from the decoders 302 and 303, while program guide data is output from the EPG management section 107. The GFX control section 304 performs graphic processing including selection of program sources, presentation of a program table, resizing of the sources, and addition of OSD, and outputs the resultant digital signal to the D/A converter 305. The D/A converter 305 converts the digital signal into an analog signal and then supplies the analog signal to the TV 13.

The scheduled recording control section 310 accepts entry of the recording schedule for digital and analog broadcasts, and instructs that a video recording operation be executed under the specified conditions. When recording schedule is entered, the scheduled recording control section 310 is provided with the program guide data by the EPG management section 107 and instructs the GFX control section 304 to present it. Also, the scheduled recording control section 310 manages the specified conditions as scheduling information. The scheduling information includes various pieces of information specifying at least the channel, recording start date and time, and the recording end date and time (or recording duration). The scheduled recording control section 310 instructs the analog tuner 101, digital tuner 105, transport decoder 106, SW 306, SW 308 and GFX control section 304 what to do and controls their operations.

The video output control section 311 instructs the SW 307 and SW 309 whether the PS/TS that has come from the tuners or the PS/TS that has come from the HDD 200 by way of the stream control section 301 should be output to the TV 13.

The network I/F 312 includes various interfaces. Examples of the network I/F 312 include an IEEE 1394 interface to establish connection with a settop box (STB) 500 and a terminal compliant with the Ethernet™ standard and connectible to the network 501. It should be noted that the network I/F 312 functions not just as an interface or a terminal but also as a controller to exchange data through the interface or the terminal.

The operating section 400 may be a switch to allow the user to operate this recorder 10. The operating section 400 outputs a channel selection control signal to change channels, a scheduling control signal to enter recording schedule, a switching control signal to switch the output modes such as recording and playback modes, and a manipulation control signal to manipulate the EPG and various types of GUI. The channel selection control signal is sent to the analog tuner 101, digital tuner 105, and transport decoder 106. The scheduling control signal is supplied to the scheduled recording control section 310. The switching control section is passed to the video output control section 311. And the manipulation control signal is transmitted to the GFX control section 304.

Hereinafter, it will be described how the recorder 10 operates. In the following example, the storage medium is supposed to be the HDD 200.

First, when the user manipulates the operating section 400 to get an EPG presented, the EPG management section 107 sends the information that makes up the electronic program guide and that has been accumulated there to the GFX control section 304. In response, the GFX control section 304 compiles an electronic program guide based on that information and outputs it to the TV 113. When the user selects a program that he or she wants to enter recording schedule on the program guide being presented on the TV 13 by manipulating the operating section 400, the scheduled recording control section 310 receives various pieces of information, including the channel number, recording start date and time, and recording end date and time (or duration), which are required to get the program recorded. Then, the scheduled recording control section 310 stores those pieces of information as scheduling information. In this manner, entry into the recording schedule is completed.

The scheduling information is managed by the scheduled recording control section 310. When the date and time specified as a piece of scheduling information has come, the scheduled recording control section 310 instructs the AV source output section 100 to receive an analog broadcast signal or a digital broadcast signal and to generate or analyze a stream based on the signal received. Furthermore, the scheduled recording control section 310 closes the SW 306 or SW 308, thereby getting the PS or TS that has been output from the AV source output section 100 stored on the HDD 200 by way of the stream control section 301. By performing these processing steps, the scheduled recording is carried out. It should be noted that the “date and time specified as a piece of the scheduling information” does not have to exactly agree with, but may also be slightly (e.g., about two minutes) earlier than, the broadcasting start time of the program. By getting the recording pre-processing started a little earlier, the recorder 10 can start the video recording operation just as intended after the operations of the respective components have settled.

Suppose the user has entered recording schedule for an analog broadcast program and a digital broadcast program, which are scheduled to be transmitted in mutually overlapping time frames. These two sets of scheduling information are entered into the scheduled recording control section 310 one after another.

When the recording start time has come, the recorder 10 of this preferred embodiment starts recording the analog broadcast program and the digital broadcast program simultaneously and in parallel with each other. More specifically, the recorder 10 gets an analog broadcast signal received by the analog tuner 101, generates a PS and eventually stores the PS representing the program on the HDD 200. Meanwhile, the recorder 10 gets a digital broadcast signal received by the digital tuner 105, generates a partial TS, and eventually stores the TS representing the program on the HDD 200.

This operation will be described in further detail. For the recording schedule for the analog broadcast program, the scheduled recording control section 310 of the recorder 10 instructs the analog tuner 101 to select the channel including the program and also instructs the SW 306 to close itself. As a result, the PS is written by the stream control section 301 on the HDD 200. On the other hand, for the recording schedule for the digital broadcast program, the scheduled recording control section 310 instructs the digital tuner 101 to select the channel including the program, also instructs the transport decoder 106 to extract TS packets, in which the data of the scheduled program is contained, from the TS on that channel, and instructs the SW 308 to close itself. As a result, the partial TS is written by the stream control section 301 on the HDD 200. By performing these processing steps, even if the digital broadcast program and the analog broadcast program are scheduled to be transmitted in mutually overlapping time frames, both of these programs can be recorded simultaneously.

It should be noted that the performance of the stream control section 301 is high enough to record a plurality of streams simultaneously. Supposing the maximum data rate of the PS is approximately 10 Mbps and that of the TS is approximately 35 Mbps, for example, the transfer rate that is acceptable for the stream control section 301 to interface with the HDD 200 will be approximately 50 Mbps, which is higher than the combined data rate of the PS and the TS. Furthermore, if not only the simultaneous write operation but also a read operation should be enabled, the transfer rate needs to be higher than the combined data rate plus the maximum read rate. Also, to satisfy these conditions, the performance of the HDD 200 should be equal to or higher than that of the stream control section 301.

When the digital broadcast program and the analog broadcast program can be recorded simultaneously, various applications are imaginable. For example, if two analog broadcast programs should be recorded in mutually overlapping time frames and if one of the two programs is also available by simultaneous broadcasting, then the recorder 10 enters recording schedule for one of the two programs as an analog broadcast program but enters recording schedule for the other program as a digital broadcast program. As a result, even if only one analog tuner is provided, two analog broadcast programs that should be recorded in mutually overlapping time frames can be recorded substantially simultaneously.

As used herein, the “simultaneous broadcasting” refers to a broadcasting service of providing the same program at the same date and time as both an analog broadcast and a digital broadcast. It should be noted that the analog broadcast program and the digital broadcast program do not have to have exactly the same contents but, for example, at least 90% of their contents should be the same. There is no need to consider the difference in video and audio qualities between the broadcast programs in determining whether those programs are the same or not. The simultaneous broadcasting will continue to be in high demand particularly until the analog broadcasting is switched into the digital broadcasting successfully. By utilizing such a broadcasting service, efficient processing is realized using the minimum required system configuration. In Japan, for example, most of terrestrial digital broadcast programs are also available by the simultaneous broadcasting. As to whether a program is available by simultaneous broadcasting or not, it can be determined by searching the program information of an EIT packet for the program ID (or event ID) or by comparing the respective titles of a digital broadcast program and an analog broadcast program to be broadcast by the same broadcaster in the same time frame by reference to the descriptor of the program information.

As used herein, the “simultaneous broadcasting” is presumed not only between an analog broadcast program and a digital broadcast program but also between any two programs that are provided by mutually different broadcasting systems. For example, the simultaneous broadcasting may also be available between a digital or analog broadcast and a broadcast that can be received through the network I/F 312. Examples of the “broadcasts that can be received through the network I/F 312” include a broadcast that is distributed by either a server 502 or a CATV broadcaster over the network 501, a digital broadcast received at the user's STB 500, and an analog broadcast to be input through an analog input terminal (not shown).

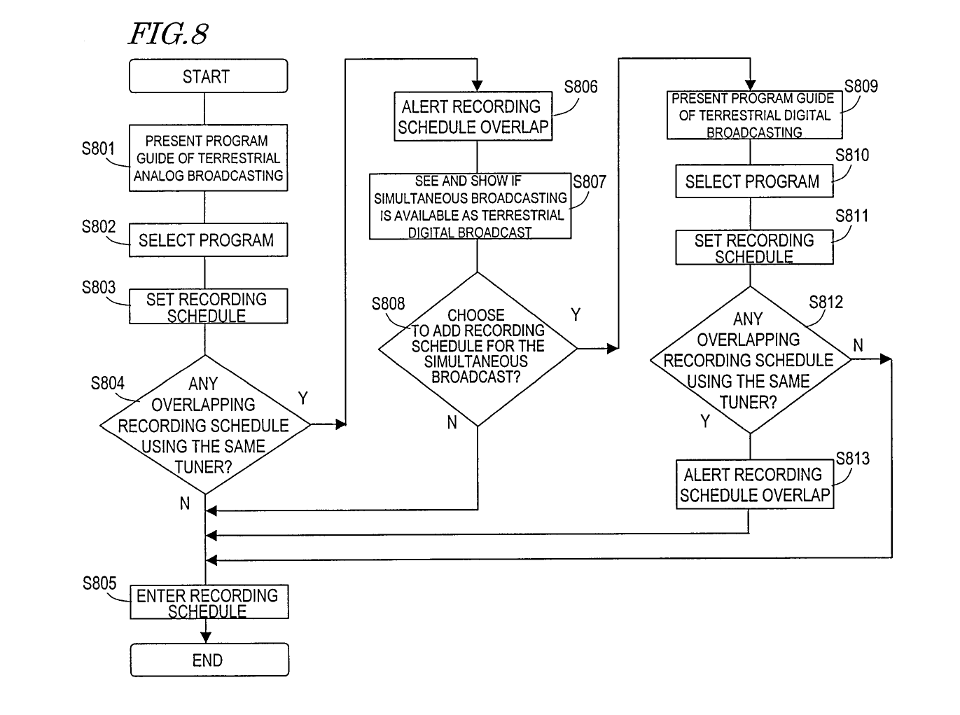

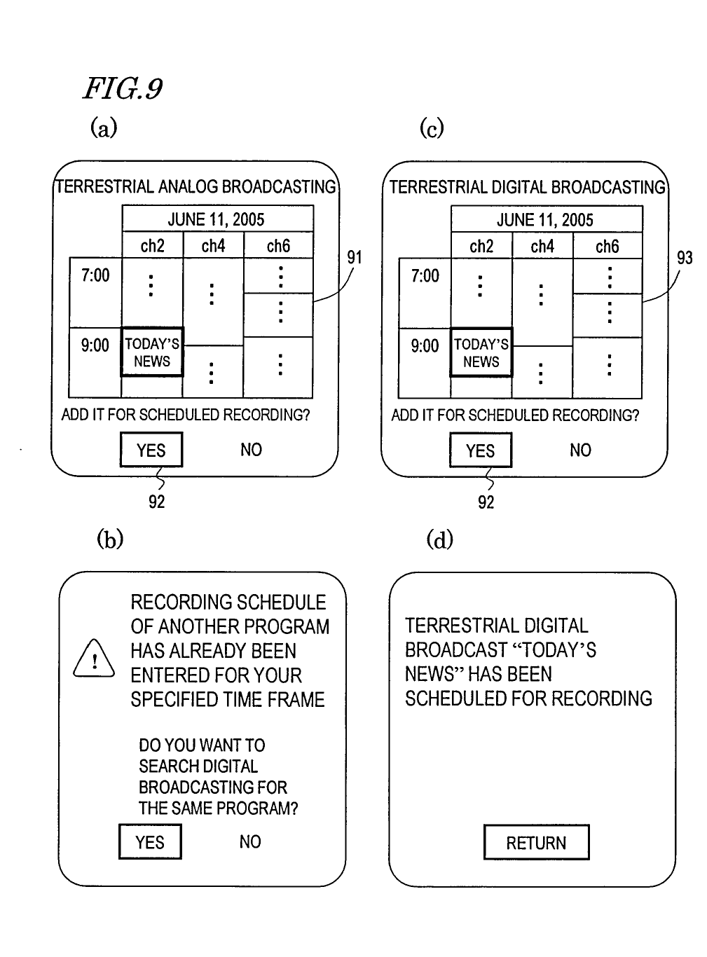

Hereinafter, the processing to be done by the recorder 10 will be described in detail with reference to FIGS. 8 and 9. FIG. 8 shows the procedure of recording schedule replacing processing that uses the simultaneous broadcasting. When the recorder 10 receives a request to enter recording schedule for a program through the operating section 400, the processing shown in FIG. 8 starts.

First, in Step S801, in accordance with the instruction given by the scheduled recording control section 310, the EPG management section 107 outputs the program guide data of terrestrial analog broadcasting. When the program guide is presented on the TV 13, the operating section 400 allows the user to select a program to be recorded in Step S802, and then allows him or her to set his or her recording schedule in Step S803. For example, FIG. 9(a) shows a terrestrial analog broadcasting program guide 91 presented on the TV 13. The program currently selected is a program entitled “Today's News”, which is highlighted with the bold frame on the program guide 91. Under the program guide 91, a highlighted display cursor 92 “YES” to enter the selection is also presented. Suppose the “enter” instruction is input to the operating section 400 in such a presentation state.

Referring back to FIG. 8, in Step S804, the scheduled recording control section 310 determines, by reference to the scheduling information that has been entered so far, whether or not the recording schedule of that program overlaps with that of another program that uses the same tuner (i.e., the analog tuner in this example). If the answer is NO, the process advances to Step S805, in which the recording schedule is entered. On the other hand, if the answer is YES, then the process advances to Step S806. It should be noted that “to overlap” refers to not only the perfect coincidence between the recording schedules of multiple programs but also a partial overlap between them.

In Step S806, the scheduled recording control section 310 displays an alert message notifying the recording schedule overlap on the TV 13. Next, in Step S807, the scheduled recording control section 310 checks out the program guide data of terrestrial digital broadcasting to see if simultaneous broadcasting of that program is available as a terrestrial digital broadcast. If the answer is YES, a message acknowledging it is displayed on the TV 13. Optionally, the availability may also be checked in accordance with the user's instruction. FIG. 9(b) shows an alert message warning the recording schedule overlap and an inquiry on the need of searching the simultaneous broadcasting schedule for the user.

Referring back to FIG. 8, in Step S808, the scheduled recording control section 310 asks the user if he or she still wants to add recording schedule for terrestrial digital broadcasting. If the answer is YES, the process advances to Step S809. Otherwise, the process advances to Step S805, in which the recording schedule of that program is entered as it is (i.e., just as originally specified). It should be noted that if the recording schedule is entered in Step S805, then there are not only the recording schedule of that program but also that of another program to be recorded in an overlapping time frame. In that case, the scheduled recording control section 310 prompts the user to set the priorities of those programs to be recorded such that the scheduled recording will be carried out according to their priorities. It should be noted that considering that the previous recording schedule could be canceled or that the on-air time of the previously scheduled program could be changed, the user's selections are accepted even if the recording schedules of the programs overlap with each other. Alternatively, the user may be prompted to choose one of those programs such that only the recording schedule of the selected program is entered but that of the other program is canceled.

In Step S809, the EPG management section 107 outputs the program guide data of the terrestrial digital broadcasting in accordance with the instruction given by the scheduled recording control section 310. FIG. 9(c) shows the program guide 93 of the terrestrial digital broadcasting that is presented on the TV 13. The following processing steps S810 through S813 shown in FIG. 8 are the same as the processing steps S802 through S806 for the terrestrial analog broadcasting. Eventually, the scheduled recording control section 310 of the recorder 10 enters recording schedule for a terrestrial digital broadcast program. FIG. 9(d) shows an example of a display representation when entry of the recording schedule for the terrestrial digital broadcast program is completed.

It should be noted that when the recorder 10 displays the message in Step S813 that multiple programs are scheduled in mutually overlapping time frames, it means that the recording schedules overlap with each other not just for the terrestrial analog broadcasting but also for the terrestrial digital broadcasting. More specifically, in this case, the recording schedules of two analog broadcast programs and one digital broadcast program (three programs in total), for which the user wants to enter, now overlap with each other. The maximum number of programs that can be recorded using the one analog tuner 101 and the one digital tuner 105 are two. That is why the scheduled recording control section 310 preferably prompts the user to set priorities of his or her selected programs for scheduled recording or cancel the recording schedule of one of those three programs. In prompting the user to set priorities of his or her programs or to remove one of them, the scheduled recording control section 310 may generate a signal to show the table of contents of the scheduling information on the screen of the TV 13. On receiving that signal, the TV 13 shows the table of contents of the recording schedule. By looking at the table, the user can set his or her priorities or cancel his or her selection by designating the programs through the operating section 400, for example. Unless these instructions are entered by the user, the scheduled recording control section 310 may automatically set the priorities of the programs and carry out the recording schedule on a first come, first serve basis.

By performing these processing steps, the scheduled recording control section 310 receives both of those two programs by controlling both the analog tuner 101 and the digital tuner 105 and gets the PS and the TS written on the HDD 200 apparently simultaneously. As described above, if the user attempts to schedule recording of two analog broadcast programs, which are scheduled in mutually overlapping time frames, both of the two programs can be recorded simultaneously by replacing one of the two programs with a digital broadcast program that is also available by simultaneous broadcasting. Similarly, even if the user attempts to schedule recording of two digital broadcast programs, which are scheduled in mutually overlapping time frames, both of the two programs can also be recorded simultaneously by replacing one of the two programs with an analog broadcast program that is also available by simultaneous broadcasting.

In the preferred embodiment described above, two programs that have been selected from two channels for scheduled recording are recorded simultaneously. Alternatively, one or both of those two programs may be recorded manually. Also, in the preferred embodiment described above, the storage medium is supposed to be a single HDD. But a plurality of storage media may be used in parallel. As another alternative, the HDD may be used in combination with a recordable removable medium such as a BD or a DVD-RAM.

### INDUSTRIAL APPLICABILITY

The present invention is applicable for use in not only recorders with two tuners but also other types of appliances and systems to record various input AV sources simultaneously.

1. A data processing apparatus that receives a first broadcast signal and a second broadcast signal from mutually different broadcasting systems to record programs, represented by these broadcast signals, on at least one storage medium, the apparatus comprising:
a first receiving section to receive the first broadcast signal;
a second receiving section to receive the second broadcast signal;
a first stream processing section for outputting a stream of a first program represented by the first broadcast signal;
a second stream processing section for outputting a stream of a second program represented by the second broadcast signal; and
a stream control section that receives the first and second streams and writes the streams on the at least one storage medium in parallel with each other.

2. The data processing apparatus of claim 1, wherein the first receiving section receives an analog broadcast signal as the first broadcast signal, and
wherein the second receiving section receives a digital broadcast signal as the second broadcast signal, and
wherein the first stream processing section generates the first stream by encoding data derived from the analog broadcast signal, and
wherein the second stream processing section generates the second stream based on a data stream derived from the digital broadcast signal.

3. The data processing apparatus of claim 1, wherein the stream control section writes the first and second streams on the same storage medium.

4. The data processing apparatus of claim 1, wherein the stream control section respectively writes the first and second streams on two different storage media.

5. The data processing apparatus of claim 1, further comprising a recording control section that receives time information specifying a recording start time and a recording end time, thereby controlling program recording in accordance with the time information,
wherein if it has been instructed to record first and second programs, which are to be delivered by a first broadcasting system in mutually overlapping time frames and if the second program is also available by simultaneous broadcasting,
the recording control section instructs the first receiving section to receive the first broadcast signal as for the first program and also instructs the second receiving section to receive the second broadcast signal from a second broadcasting system as for the second program.

6. The data processing apparatus of claim 5, wherein the second stream processing section has obtained in advance program guide data, specifying the on-air time of the second program to be broadcast by the second broadcasting system, from the second broadcast signal, and
wherein by reference to the program guide data, the recording control section tells the second receiving section that the second program is available by the simultaneous broadcasting.

7. The data processing apparatus of claim 6, wherein the recording control section outputs a signal notifying that the second program has been found to be available by the simultaneous broadcasting and is recordable by the second broadcasting system.

8. The data processing apparatus of claim 7, wherein the recording control section receives a response to the notifying signal and gives an instruction to the second receiving section.
